(19) United States
(12) Patent Application Publication
(10) Pub. No.: US 2025/0325903 A1
(43) Pub. Date: Oct. 23, 2025

(54) STEERING WHEEL HAPTIC FEEDBACK SYSTEM AND METHOD FOR OPERATING A VIDEO GAME

(71) Applicant: Ford Global Technologies, LLC, Dearborn, MI (US)

(72) Inventors: Leonardo Alonso Huitron Rodriguez, Naucalpan de Juárez (MX); Brian Erick Munive, Tlaxcala (MX); Osvelia Urban, Naucalpan de Juárez (MX)

(73) Assignee: Ford Global Technologies, LLC, Dearborn, MI (US)

(21) Appl. No.: 18/643,463

(22) Filed: Apr. 23, 2024

(51) Int. Cl. A63F 13/285; A63F 13/803

(52) U.S. Cl. CPC A63F 13/285; A63F 13/803

(57) ABSTRACT

A vehicle comprising a steering wheel, a plurality of haptic feedback devices located on the steering wheel, a display for displaying video game images, and a controller configured to execute a video game and display video game images on the display, wherein the controller executes the video game using the steering wheel as an input and provides haptic feedback to the steering wheel by activating one or more of the plurality of haptic feedback devices on the steering wheel.

### FIELD OF THE DISCLOSURE

The present disclosure generally relates to user feedback devices on a vehicle, and more particularly relates to the use of haptic feedback devices such as on a steering wheel of a motor vehicle.

### BACKGROUND OF THE DISCLOSURE

Motor vehicles are often equipped with haptic devices that provide a force feedback or vibration to the driver of the vehicle. Haptic feedback devices are typically employed for driving applications such as lane departure, for example. It would be desirable to employ haptic feedback devices for other applications on board a vehicle.

### SUMMARY OF THE DISCLOSURE

According to a first aspect of the present disclosure, a vehicle comprises a steering wheel, a plurality of haptic feedback devices located on the steering wheel, a display for displaying video game images, and a controller configured to execute a video game and display video game images on the display, wherein the controller executes the video game using the steering wheel as an input and provides haptic feedback to the steering wheel by activating one or more of the plurality of haptic feedback devices on the steering wheel.

Embodiments of the first aspect of the present disclosure can include any one or a combination of the following features:
the plurality of haptic feedback devices includes at least four haptic feedback devices distributed along the length of the steering wheel;
the at least four haptic feedback devices are evenly distributed along the length of the steering wheel;
each of the plurality of haptic devices generates a force feedback vibration;
each of the plurality of haptic feedback devices comprises one of an eccentric motor and a voice activated motor;
the controller executes the video game using a vehicle infotainment system;
an infotainment input for providing a user input to the video game;
the steering wheel is used as an input to the video game;
the steering wheel is used as an input to the video game when the steering wheel is not in the driving mode; and
a seat having a plurality of seat mounted haptic feedback devices in the seat.

According to a second aspect of the present disclosure, a motor vehicle comprises a steering wheel for steering the motor vehicle in a driving mode, a plurality of haptic feedback devices located on the steering wheel and configured to generate force feedback vibration, an infotainment system configured to operate a video game and having a display for displaying video game images, and a controller configured to execute the video game and display the video game images on the display, wherein the controller executes the video game using the steering wheel as an input to the video game when the steering wheel is not in the driving mode and provides haptic feedback to the steering wheel by activating one or more of the plurality of haptic feedback devices in the steering wheel.

Embodiments of the second aspect of the present disclosure can include any one or a combination of the following features:
the plurality of haptic feedback devices includes at least four haptic feedback devices distributed along the length of the steering wheel;
the at least four haptic feedback devices are evenly distributed along the length of the steering wheel;
each of the plurality of haptic feedback devices comprises one of an eccentric motor and a voice activated motor; and
an infotainment input for providing a user input to the video game.

A method of playing a video game on a motor vehicle is also provided. The method includes steps of executing the video game with a controller, displaying video images of the video game on a display, receiving video game steering commands from a steering wheel of the motor vehicle when the vehicle is not in a driving mode, and generating haptic feedback vibration in the steering wheel as feedback for the video game.

Embodiments of the third aspect of the present disclosure can include any one or a combination of the following features:
the step of executing the video game is performed by an infotainment system;
the haptic feedback vibration is generated by a plurality of haptic feedback devices located on the steering wheel;
each of the plurality of haptic feedback devices comprises an eccentric motor or a voice activated motor; and
the video images are displayed on the display mounted in a cabin interior of the motor vehicle.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings;

FIG. 1 is a schematic top view of a motor vehicle equipped with haptic feedback devices generally located in the steering wheel and driver's seat, according to one example;

FIG. 2 is a forward-looking view of the driver cockpit illustrating the steering wheel with haptic feedback devices and a touchscreen display configured to provide a video game display;

FIG. 3 is a block diagram of a haptic feedback controller configured to control the haptic feedback devices for various applications;

FIG. 4 is a flow diagram illustrating a routine for employing the steering wheel haptic feedback devices while playing in a video game mode;

FIG. 5 is a flow diagram illustrating a routine for controlling the steering wheel haptic devices for a heated steering wheel mode; and

FIG. 6 is a flow diagram illustrating a routine for controlling the haptic feedback devices to provide a massaging device in a spa mode.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

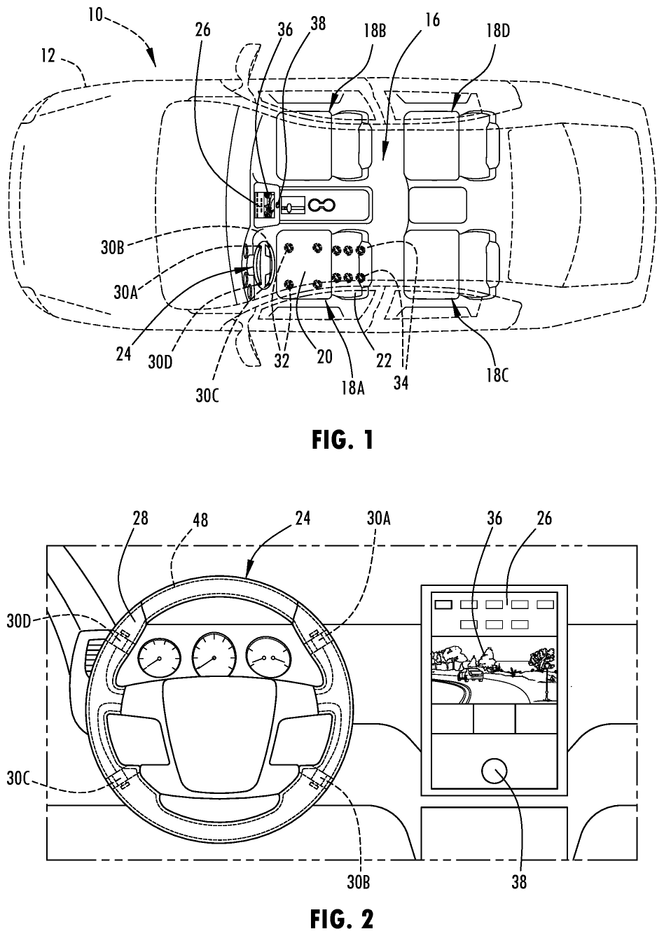

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle having a haptic feedback system and method. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIG. 1, a motor vehicle 10 is generally illustrated equipped with a vehicle haptic feedback system generally positioned proximate to a driver cockpit in the vehicle interior where a driver of the motor vehicle 10 may be seated. The motor vehicle 10 may be a wheeled motor vehicle having a plurality of road wheels and a vehicle body 12 generally defining the vehicle interior which is referred to as a passenger compartment 14. While a wheeled motor vehicle 10 is generally shown and described herein, it should be appreciated that other vehicles such as boats, trains, planes, and other vehicles may be equipped with the vehicle haptic feedback system and method of use for various applications.

The motor vehicle 10 is configured with a seating arrangement that includes one or more seats shown in one example having seat assemblies 18A-18B within the passenger compartment 16 of the motor vehicle 10. In a typical passenger seating arrangement of a motor vehicle, the front row of bucket seats may include two seats spaced apart including a driver's seat assembly 18A and a front row passenger seat assembly 20B. The seating arrangement may include a second row of seating including a third seating assembly 20C and a fourth seating assembly 20D, in this example, and additional rows of seating.

As seen in FIGS. 1 and 2, the motor vehicle 10 has a steering wheel 24 located generally in front of the seating space of the driver's seat assembly 18A. The steering wheel 24 includes a generally circular or ring-shaped steering wheel rim 28 generally configured to be gripped and manipulated by the hands of a driver of the motor vehicle 10 to rotate clockwise and counterclockwise to steer the motor vehicle 10. The steering wheel 24 may further include various features and components such as steering wheel heaters (48), user input controls and switches, gauges, airbags, and a horn, for example, as is commonly found in a conventional steering wheel. The steering wheel 24 generally extends vehicle rearward from the steering column which is located within the dashboard of the motor vehicle 10.

The steering wheel 24 is configured to include a plurality of haptic feedback devices shown in one example as four haptic feedback devices 30A-30D, each configured to provide a force feedback in the form of a vibrating device. In the example shown, the four haptic feedback devices 30A-30D are arranged within the rim 28 of the steering wheel 24 and are generally evenly spaced around a circular length of the rim 28. The haptic feedback devices 30A-30D may include eccentric motors, also referred to as eccentric rotating mass motors, that are electrically powered to generate a force feedback vibration, according to one example. According to another example, the haptic feedback devices 30A-30D may include voice coil motors that are electrically powered to generate the force feedback vibration. The haptic feedback devices 30A-30D may be connected to a rigid core of the rim 28 which may be covered with a polymeric or leather cover, for example. The steering wheel 24 may have electric heaters 48 located in or under the cover to heat the rim 28. All of the haptic feedback devices 30A-30D, or select ones of the haptic feedback devices 30A-30D, may be activated to generate force feedback vibration within the rim 28 of the steering wheel 24. The force feedback vibration is intended to provide vibratory feedback to the hands of the driver of the motor vehicle 10 while gripping the rim 28 of the steering wheel 24.

The driver seat assembly 18A is also configured to include a plurality of haptic feedback devices 32 located in the seat base 20 of the driver seat assembly 18A. In the example shown, four haptic feedback devices 32 are located spaced apart in the front left corner, right left corner, rear right corner, and rear left corner of the seat base 20. Further, the driver seat assembly 18A may include a plurality of haptic feedback devices 34 located spaced apart in the seat back 22. The haptic feedback devices 34 may be distributed throughout the seat back 22 and within the head rest at the top end of the seat back 22. It should be appreciated that the haptic feedback devices 32 and 34 may be activated simultaneously or may be selectively activated one or more at a time and in a certain pattern to provide force feedback in the form of vibrating feedback to the driver of the motor vehicle 10 and may also be activated to provide a massaging effect on the driver seated in the driver seat assembly 18A of the motor vehicle 10.

The motor vehicle 10 also includes an infotainment system having a touchscreen display 26 which provides a human machine interface (HMI) display configured to provide data, maps, video, user input controls, and other human machine interface (HMI) functions. The infotainment system and the touchscreen display 26 may further include an infotainment input 38 which may be a rotatable input knob configured to scroll through input selections that also may be depressible to select the various input selections. The infotainment input 38 may be used to select input commands and select push button commands for operating the touchscreen display 26 and for operating other vehicle functions and infotainment functions, such as for actively playing a video game 46, for example, when the vehicle is not operated and is stopped.

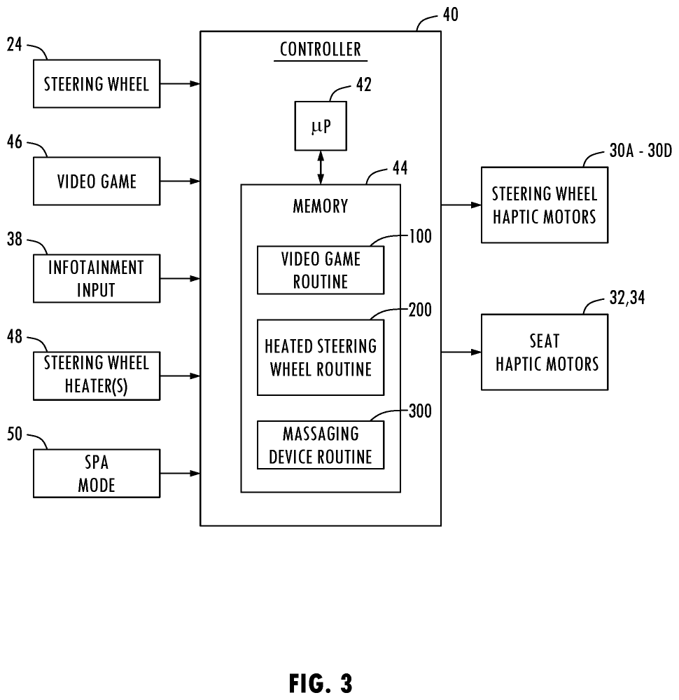

Referring to FIG. 3, the motor vehicle 10 is shown configured with a haptic controller 40 that may control the haptic feedback devices 30A-30D located on the steering wheel 24 and the haptic feedback devices 32 and 34 located on the driver seat assembly 18A. The haptic feedback controller 40 may include a microprocessor 42 and memory 44. The microprocessor 42 is one example of a digital controller, however, it should be appreciated that other analog and/or digital control circuitry may be employed. Stored within memory 44 and executed by the microprocessor 42 are a plurality of control routines including a video game routine 100, a heated steering wheel routine 200, and a massaging device routine 300. The haptic controller 40 receives various inputs including inputs from a video game 46 which may be operated by the infotainment system or a gaming device and displayed on the touchscreen display or infotainment center of the vehicle when the vehicle is stopped and not operating. In addition, the infotainment input 38 is provided to the haptic controller 40 as an input.

The vehicle steering wheel 24 may be used to steer the motor vehicle 10 in a driving mode and may be used as a virtual steering wheel to play a video game such as a steering input for a race game when the vehicle is stopped and not in the driving mode. The vehicle steering wheel 24 may be equipped with electric heaters 48, and the heaters 48 may provide an input to the haptic controller 40 indicative of the activation state of the heaters 48. Further, the motor vehicle 10 may be operated in a spa mode 50 to provide a massaging function. The spa mode 50 may generate an activation state signal that may be provided as an input to the haptic controller 40.

The haptic controller 40 processes the various inputs including inputs from the video game 46, the infotainment input 38, the steering wheel heaters 48, and the spa mode 50, and executes one or more of the control routines 100, 200 and 300 depending on which control functions are being implemented to generate output signals. The output signals may include providing output control signals to the steering wheel haptic devices 30A-30D, e.g., motors, to actuate the haptic motors in the steering wheel according to the one or more of the control routines. Additionally, the haptic controller 40 may provide output signals to the seat mounted haptic feedback devices 32 and 34, motors, according to the one or more control routines 100, 200 and 300.

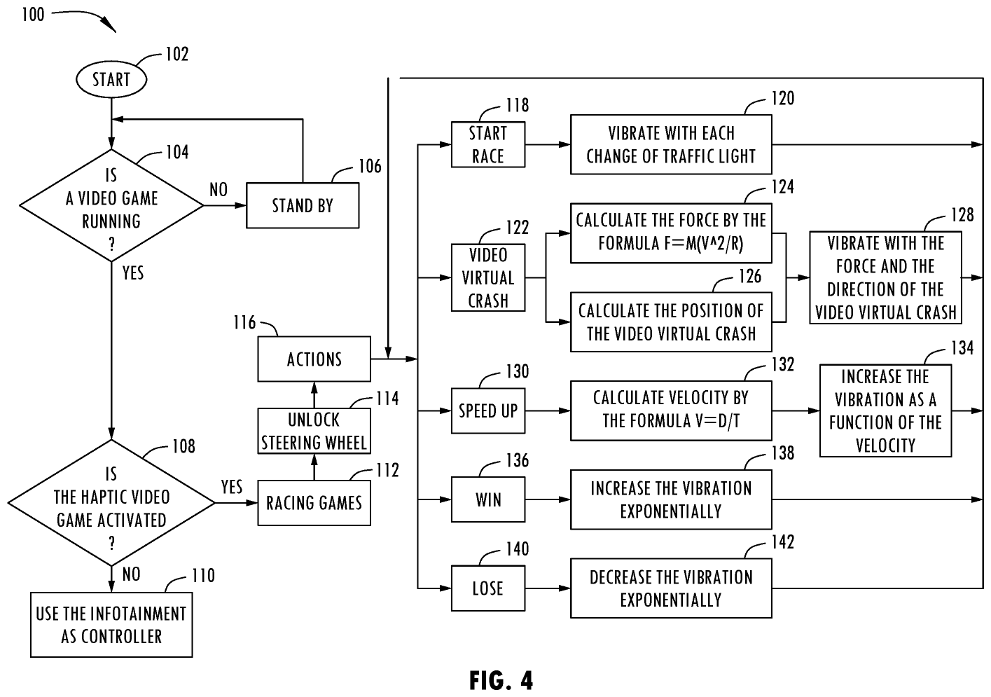

The haptic controller 40 may execute the video game routine 100, when the haptic video game is activated, pursuant to the control routine shown in FIG. 4, according to one example. The video game routine 100 starts at step 102 and proceeds to decision step 104 to determine if a video game application mode is running and, if not, moves to a standby mode at block 106, before returning to step 104. If a video game application mode is running, routine 100 proceeds to decision step 108 to determine if the haptic video game is activated and, if not, the infotainment system operates in a vehicle controller mode. If the haptic video game is activated, routine 100 proceeds to step 112 to perform a gaming function such as a car road racing video game, according to one example. Next, at step 114, with the vehicle stopped and inoperable, the steering wheel is unlocked and gaming actions are implemented at step 116.

Pursuant to the video game, routine 100 may proceed to start the video game race at block 118 and to vibrate the haptic feedback devices with each change of a virtual traffic light, for example. Pursuant to the video game, for a video generated virtual race car crash, routine 100 may proceed to calculate the virtual forces by the formula set forth in block 124 and calculate the position of the video crash in block 126 before vibrating the haptic feedback devices with the force in the direction of the video game generated crash at block 128. Pursuant to the video game, routine 100 may proceed to detect a vehicle speed up event in the video game at block 130 and may calculate the virtual velocity by the formula set forth in block 132 before increasing the vibration of the haptic feedback devices as a function of the virtual velocity. Pursuant to the video race game example shown and described herein, routine 100 may proceed to determine if the gaming player is winning at block 136 and, if so, may increase the vibration of the haptic feedback devices exponentially at block 138. Contrary, pursuant to the video game example, if the gaming player is losing at step 140, routine 100 may decrease the vibration of the haptic feedback devices exponentially at block 142.

Accordingly, the haptic feedback devices may be activated and controlled to help support playing a video game with the steering wheel and by vibrating the steering wheel on the motor vehicle when the vehicle is not operating and is not moving. It should be appreciated that the gaming player may rotate the steering wheel to play the video game such as to virtually steer a race car in the video game. The steering wheel may be vibrated as a force feedback to give a sensation related to a gaming aspect. Additionally, the haptic feedback devices in the driver seat may be activated to vibrate according to the video game.

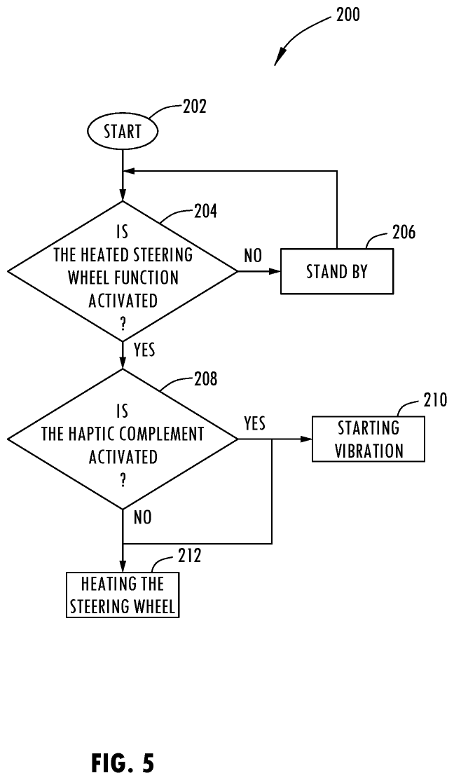

Referring to FIG. 5, one example of the control routine for a heated steering wheel routine 200 is shown. Routine 200 begins at step 202 and proceeds to decision step 204 to determine if the heated steering wheel function is activated and, if not, proceeds to decision step 206 to standby before returning to step 204. Next, if the heated steering wheel function is activated, routine 200 proceeds to decision step 208 to determine if the haptic complement associated with a heater is activated and, if so, it activates vibration of the haptic feedback devices on the steering wheel. If the haptic complement is not activated, the steering wheel is simply heated 212 without vibrations of the haptic steering wheel feedback devices. Accordingly, the haptic feedback devices located in the steering wheel may be used to provide vibratory feedback to the driver of the motor vehicle to indicate that the heated steering wheel is energized.

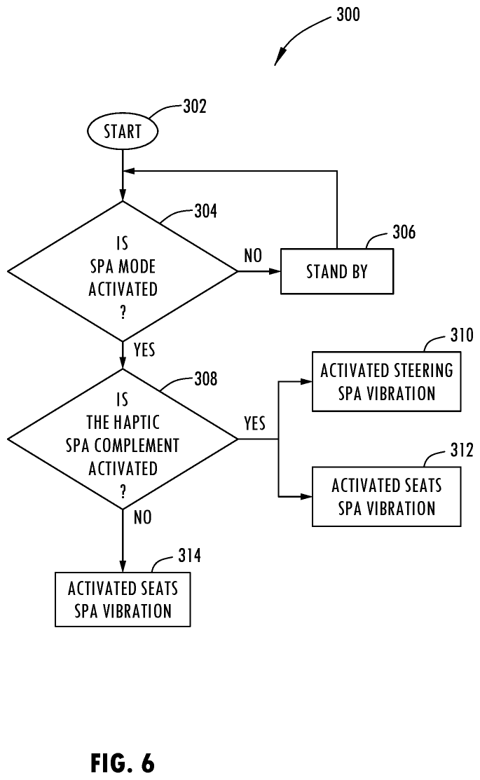

Referring to FIG. 6, one example of a massaging device routine 300 operable in a spa mode is illustrated. Massaging routine 300 starts at step 302 which may be pursuant to a spa mode implemented on the motor vehicle. The massaging routine 300 then proceeds to decision block 304 to determine if the spa mode is activated and, if not, remains in a standby mode in block 306 before returning to step 304. If the spa mode is activated, routine 300 proceeds to decision step 308 to determine if the haptic spa complement associated with the spa mode is activated and, if not, activates the seats spa mode vibration in step 314. If the haptic spa complement is activated, routine 300 activates both the steering spa vibration at step 310 and the seats spa vibration at step 312. Accordingly, the haptic feedback devices may be controlled to help provide a massaging effect pursuant to a spa mode on board a motor vehicle. It should be appreciated that the massaging routine 300 may control haptic feed devices in the driver seat and other seats onboard the vehicle.

Accordingly, haptic feedback devices are advantageously employed on a steering wheel and controlled to provide enhanced operation of a video game to generate vibratory feedback, according to one application. According to another application, the haptic feedback devices are employed in the steering wheel to provide enhanced vibratory feedback for a heated steering wheel. Further, various haptic feedback devices may be employed in the steering wheel and seats on the vehicle to provide an enhanced vibratory massaging effect such as for a spa mode on board the motor vehicle.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle comprising:
a steering wheel;
a plurality of haptic feedback devices located on the steering wheel;
a display for displaying video game images; and
a controller configured to execute a video game and display video game images on the display, wherein the controller executes the video game using the steering wheel as an input and provides haptic feedback to the steering wheel by activating one or more of the plurality of haptic feedback devices on the steering wheel.

2. The vehicle of claim 1, wherein the plurality of haptic feedback devices includes at least four haptic feedback devices distributed along the length of the steering wheel.

3. The vehicle of claim 2, wherein the at least four haptic feedback devices are evenly distributed along the length of the steering wheel.

4. The vehicle of claim 1, wherein each of the plurality of haptic devices generates a force feedback vibration.

5. The vehicle of claim 4, wherein each of the plurality of haptic feedback devices comprises one of an eccentric motor and a voice activated motor.

6. The vehicle of claim 1, wherein the controller executes the video game using a vehicle infotainment system.

7. The vehicle of claim 6, further comprising an infotainment input for providing a user input to the video game.

8. The vehicle of claim 1, wherein the steering wheel is used as an input to the video game.

9. The vehicle of claim 8, wherein the steering wheel is used as an input to the video game when the steering wheel is not in the driving mode.

10. The vehicle of claim 1, further comprising a seat having a plurality of seat mounted haptic feedback devices in the seat.

11. A motor vehicle comprising:
a steering wheel for steering the motor vehicle in a driving mode;
a plurality of haptic feedback devices located on the steering wheel and configured to generate force feedback vibration;
an infotainment system configured to operate a video game and having a display for displaying video game images; and
a controller configured to execute the video game and display the video game images on the display, wherein the controller executes the video game using the steering wheel as an input to the video game when the steering wheel is not in the driving mode and provides haptic feedback to the steering wheel by activating one or more of the plurality of haptic feedback devices in the steering wheel.

12. The motor vehicle of claim 11, wherein the plurality of haptic feedback devices includes at least four haptic feedback devices distributed along the length of the steering wheel.

13. The motor vehicle of claim 12, wherein the at least four haptic feedback devices are evenly distributed along the length of the steering wheel.

14. The motor vehicle of claim 11, wherein each of the plurality of haptic feedback devices comprises one of an eccentric motor and a voice activated motor.

15. The motor vehicle of claim 11, further comprising an infotainment input for providing a user input to the video game.

16. A method of playing a video game on a motor vehicle, comprising:
executing the video game with a controller;
displaying video images of the video game on a display;
receiving video game steering commands from a steering wheel of the motor vehicle when the vehicle is not in a driving mode; and
generating haptic feedback vibration in the steering wheel as feedback for the video game.

17. The method of claim 16, wherein the step of executing the video game is performed by an infotainment system.

18. The method of claim 16, wherein the haptic feedback vibration is generated by a plurality of haptic feedback devices located on the steering wheel.

19. The method of claim 18, wherein each of the plurality of haptic feedback devices comprises an eccentric motor or a voice activated motor.

20. The method of claim 16, wherein the video images are displayed on the display mounted in a cabin interior of the motor vehicle.
